(19) United States
(12) Patent Application Publication
(10) Pub. No.: US 2017/0021272 A1
(43) Pub. Date: Jan. 26, 2017

(54) Virtual Reality Headset

(71) Applicant: Saj Muzaffar, London (GB)

(72) Inventor: Saj Muzaffar, London (GB)

(21) Appl. No.: 15/142,385

(22) Filed: Apr. 29, 2016

(30) Foreign Application Priority Data
Jul. 23, 2015 (GB) GB1513050.3

(51) Int. Cl. A63F 13/23; A63F 13/213

(52) U.S. Cl. CPC A63F 13/23; A63F 13/213

(57) ABSTRACT

A user input device comprising a sensor arrangement arranged to detect user interaction with the user input device, and an optical or audio transducer responsive to said sensor arrangement and arranged in use to transmit an optical or audio output signal to an optical or audio sensor of a separate mobile computing device, said output signal encoding instructions for launching or controlling an app.

CROSS-REFERENCE TO RELATED APPLICATIONS

This application claims priority to United Kingdom Patent Application Number GB1513050.3, filed Jul. 23, 2015 entitled “Virtual reality Headset User Input system”.

### BACKGROUND OF THE INVENTION

1. Field of the Invention

The present invention relates particularly hut not exclusively to controlling virtual reality headsets that work with mobile devices.

2. Description of Related Art

VR headsets that work with mobile devices normally have very limited, if any, user interaction/control due to the mobile device being placed inside the VR headset and making access to the controls difficult. In addition, because these types of VR headsets are low in cost most users are unlikely to purchase an expensive game controller (eg. Bluetooth gamepad) and therefore an important element of the VR experience (eg moving around in a virtual world) would be lost.

The Google cardboard Virtual reality (VR) headsets that worth with smartphone allows one type of user selection/interaction, which is achieved by sensing a change in the magnetic field around the device by either moving a magnet or piece of metal (washer) attached to the VR device. This has limited user interaction and is not suitable for people with pacemakers.

It would be desirable to provide users with more user interactivity than currently available and that would work with most smart phones and tablets.

Recently VR apps (the term apps refers to software applications or games on tablets smart-phones or the like) have become very popular.

Therefore it is an object of this invention to provide users a simple, low cost more interactive VR experience in which the above disadvantages are overcome or alleviated.

### BRIEF SUMMARY OF THE INVENTION

In one aspect of the invention provides a VR arrangement comprising a mobile device coupled to a VR headset wherein the mobile device is arranged to detect different audio signals and convert the said audio signals to user interactions.

In another aspect of the invention provides a user input device comprising a sensor arrangement arranged to detect user interaction therewith, and an audio transducer responsive to said sensor arrangement and arranged in use to transmit audio output signal to an audio sensor of a separate mobile device, said output signal encoding gameplay or control of a VR game or app.

In another aspect the invention provides a mobile device programmed to decode audio input signal encoding game play and to process the decoded game play signal to display an output.

The said user interactions may for example be used to control the movement (forward, backward, left, right, and jump) of an object or a character in a virtual reality game or application.

The said user interactions may include but may not limited to selecting, touching, moving or placing an item or object, character in a virtual reality world or user interface or a combination thereof.

Typically the mobile device will be a mobile device, eg a tablet computer or a mobile communication device such as a smartphone.

The invention also includes a computer program product embodying program code means executable by a processor of the mobile device for decoding and processing said audio signals to a display.

In order to link input system to the mobile device the player downloads and installs the game software related to the game or VR headset.

The audio transducer may optionally generate ultrasonic signals.

In one embodiment said transducer is an audio transducer having a variable sound output and said output signal encodes user interaction according to the frequency of said output sound.

Optionally the user input device includes means for locating a mobile computing device on said input device with its audio sensor arranged to receive said optical or audio output signal. The audio transducer may be eg a piezoelectric transducer and may optionally generate ultrasonic signals.

In one embodiment a sensor arrangement arranged to detect user interaction is provided with audio transducer responsive to said sensor arrangement and arranged in use to transmit audio output signal to an audio sensor of a separate processing device (not necessarily a mobile computing device), said output signal encoding instructions for launching or controlling application software of the processing device.

In this aspect the processing device could for example be a display apparatus

In another aspect the invention provides a mobile computing 1-vice programmed to decode an audio input signal encoding instructions and to launch or control an app or game according to the decoded instructions.

The invention also includes a computer program product embodying program code means executable by a processor of the mobile computing device for decoding said optical or audio input signal and processing the decoded user signal to launch or control said app according to the decoded instructions.

The computer program product may also for example provide one or more of user interaction, selection and control, and may for example provide one or more of video, animation, sound or music playback or a combination thereof.

In preferred embodiments the user input device is arranged to send and/or receive user interaction data encoded as an audio (including ultrasonic) to a computing device.

Preferably the transducer outputs different sound frequency based on different user interaction data.

In another of the present invention the transducer may output an audio signal that may be inaudible to the human ear.

The computing device usable with the user input of the invention may for example be a smartphone or tablet computer.

### BRIEF DESCRIPTION OF THE SEVERAL VIEWS OF THE DRAWINGS

FIG. 1 is a diagram illustrating a virtual reality headset user input system according to an embodiment of the present invention.

### DETAILED DESCRIPTION OF THE INVENTION

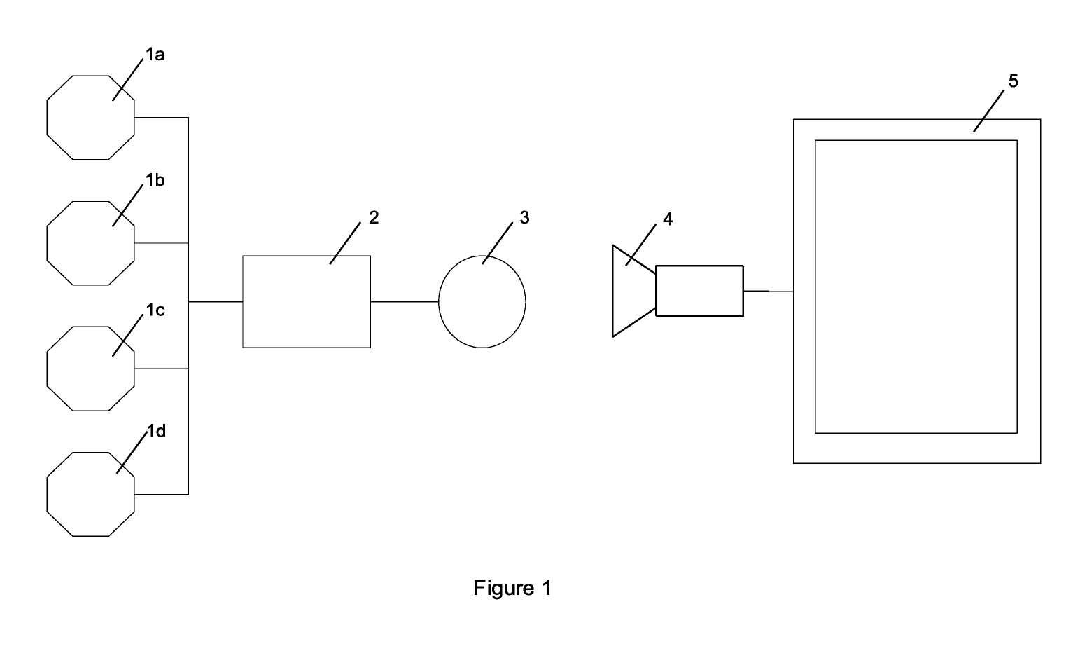

Preferred embodiments of the present invention will now be described by way of example only with reference to FIGS. 1 of the accompanying drawings, wherein:

The apparatus of the embodiment depicted in FIG. 1 includes switches 1 (A-D), on the User Input device, and microprocessor 2 which is used to receive all signals from switches 1 (A-D) and interpret which switch was triggered and output signals to speaker 3 to produce an audio signal that represents which switch 1 was triggered. This audio signal is then identified by microphone 4 of separate smartphone 5.

A number of pre-marked buttons A-D are printed on the User Input device.

In order to link the smartphone 5 to the User Input device the user downloads and installs the software related to either the VR headset and/or game, (first time only).

To start interacting, the software is run on the mobile 5, the application is run, (the microphone is switched on and waits until it detects any sound). The user then either presses on switch 1A, which turns on and a signal is sent to microprocessor. Microprocessor 2 recognizes that switch 1A, has been pressed and accordingly sends a signal to speaker. In this embodiment, operation of switch 1A is represented by a sound signal. As soon as the speaker emits the sound signal, the software learns that switch 1A has been activated and moves the game character forward, the user may then press switch 1E and the microprocessor recognises 1E has been activated and a different sound signal is emitted, which works as above, except that this sound signal causes the game character to move left.

In another embodiment the input system may be disposable.

In another embodiment it may be made or encased in cardboard or the like.

In another embodiment, the casing may be constituted by a printed overlay which may be replaced for different games and or different VR headsets.

Although the invention has been described in considerable detail in language specific to structural features and or method acts, it is to be understood that the invention defined in the appended claims is not necessarily limited to the specific features or acts described. Rather, the specific features and acts are disclosed as exemplary preferred forms of implementing the claimed invention. Stated otherwise, it is to be understood that the phraseology and terminology employed herein, as well as the abstract, are for the purpose of description and should not be regarded as limiting. Therefore, while exemplary illustrative embodiments of the invention have been described, numerous variations and alternative embodiments will occur to those skilled in the art. Such variations and alternate embodiments are contemplated, and can be made without departing from the spirit and scope of the invention.

What is claimed is:

1. A user input device comprising:
a sensor arrangement arranged to detect user interaction with the user input device, and an optical or audio transducer responsive to said sensor arrangement and arranged in use to transmit an optical or audio output signal to an optical or audio sensor of a separate mobile computing device, said output signal encoding instructions for launching or controlling an app.

2. The user input device of claim 1, wherein the user input device is for use with a virtual reality headset.

3. The user input device of claim wherein the user input device is arranged to generate audio signals for gameplay

4. The user input device of claim 1, further comprising a mobile computing device programmed to decode an audio input signal encoding gameplay to user interaction according to the output signal encoding instructions.

5. A user input device comprising:
a sensor arrangement arranged to detect user interaction therewith, and an audio transducer responsive to said sensor arrangement and arranged in use to transmit an audio output signal to an audio sensor of a separate processing device, said output signal encoding of user gameplay or controlling application software of the processing device.

6. The user input device of claim 5, further comprising a virtual game playing apparatus and a mobile computing device, wherein an audio sensor of said mobile computing device being arranged to receive said audio output signal from said audio transducer.
